(19) United States
(12) Patent Application Publication
(10) Pub. No.: US 2024/0390875 A1
(43) Pub. Date: Nov. 28, 2024

(54) PLATINUM GROUP METAL CAPTURE MATERIALS

(71) Applicant: BASF CORPORATION, Florham Park, NJ (US)

(72) Inventors: Xinyi WEI, Iselin, NJ (US); Gerard Diomede LAPADULA, Iselin, NJ (US); Kevin BEARD, Iselin, NJ (US); Weiyong TANG, Iselin, NJ (US); Jian LI, Shanghai, Shanghai (CN)

(21) Appl. No.: 18/695,194

(22) PCT Filed: Sep. 28, 2022
(86) PCT No.: PCT/US2022/077132

§ 371 Date: Mar. 25, 2024

(30) Foreign Application Priority Data
Sep. 30, 2021 (WO) PCT/CN2021/122206

(51) Int. Cl. B01J 20/04; B01D 53/94; B01J 23/40

(52) U.S. Cl. CPC B01J 20/041; B01D 53/9477; B01J 23/40; B01D 2253/1124; B01D 2255/102; B01D 2257/404; B01D 2257/502; B01D 2257/60; B01D 2258/01

(57) ABSTRACT

Disclosed herein are platinum group metal capture materials comprising an alkaline earth metal oxide. Also disclosed herein are catalytic articles, exhaust gas treatment systems, and methods of treating an exhaust gas comprising the same. Some embodiments of the present disclosure relate to gas treatment systems comprising a means for oxidizing carbon monoxide and oxidizing hydrocarbons, a means for capturing a volatilized platinum group metal, and a means for selectively reducing nitrogen oxides.

This application claims the benefit of priority to International Application No. PCT/CN2021/122206, filed on Sep. 30, 2021: the disclosure of this application is incorporated herein by reference in its entirety.

Disclosed herein are platinum group metal capture materials comprising an alkaline earth metal oxide. Also disclosed herein are catalytic articles, exhaust gas treatment systems, and methods of treating an exhaust gas comprising the same.

Platinum group metals may volatilize upon exposure to elevated temperatures. For example, platinum group metals in various catalytic and exhaust gas treatment systems may volatilize upon exposure to an exhaust gas. In some cases, volatilized platinum group metals may be problematic and may, for example, poison a downstream catalyst. Illustratively, in an exhaust gas system having a NOₓ reduction component downstream of an oxidation catalyst comprising a platinum group metal, exhaust gas may volatilize a portion of the platinum group metal in the oxidation catalyst and carry the volatilized platinum group metal downstream to the NOₓ reduction component, where it may impair the NOₓ reduction component's ability to function properly.

Accordingly, there is a need for platinum group metal capture materials capable of capturing volatilized platinum group metals generated during elevated temperature use cases for catalytic and exhaust gas treatment systems.

Some embodiments of the present disclosure relate to platinum group metal capture materials (such as a Pt trap) comprising an alkaline earth metal oxide.

In some embodiments, a platinum group metal capture material comprises an alkaline earth metal oxide, and the platinum group metal capture material does not comprise a transition metal except, optionally, zirconium, and the platinum group metal capture material does not comprise a rare earth metal.

In some embodiments, the alkaline earth metal oxide is chosen from magnesium oxide, barium oxide, calcium oxide, strontium oxide, and combinations thereof.

In some embodiments, the platinum group metal capture material further comprises at least one metal oxide chosen from alumina, zirconia, and combinations thereof.

In some embodiments, the platinum group metal capture material has from about 30 weight % to about 100 weight % of magnesium oxide by total weight of the platinum group metal capture material.

In some embodiments, the platinum group metal capture material consists essentially of magnesium oxide.

In some embodiments, the platinum group metal capture material consists essentially of aluminum magnesium oxide, zirconia magnesium oxide, aluminum calcium oxide, zirconia calcium oxide, or combinations thereof. In some embodiments, the platinum group metal capture material consists essentially of aluminum magnesium oxide, zirconia magnesium oxide, aluminum calcium oxide, or zirconia calcium oxide.

Some embodiments of the present disclosure relate to catalytic articles comprising a platinum group metal capture material.

In some embodiments, a catalytic article comprises a platinum group metal capture material as disclosed herein downstream of a catalytic composition comprising a platinum group metal.

In some embodiments, the platinum group metal capture material has a washcoat loading of at least about 0.1 g/in³.

In some embodiments, the platinum group metal capture material and the catalytic composition are in a layered arrangement and/or a zoned arrangement. In some embodiments, the platinum group metal capture material and the catalytic composition are in a layered arrangement. In some embodiments, the platinum group metal capture material and the catalytic composition are in a zoned arrangement.

Some embodiments of the present disclosure relate to an exhaust gas treatment system comprising a platinum group metal capture material.

In some embodiments, the exhaust gas treatment system comprises an engine and a catalytic article as disclosed herein.

In some embodiments, the exhaust gas treatment system comprises a platinum group metal capture material as disclosed herein downstream of a catalytic composition comprising a platinum group metal, wherein the platinum group metal capture material and the catalytic composition are on different substrates.

Some embodiments of the present disclosure relate to methods of treating an exhaust gas comprising contacting the exhaust gas with a catalytic composition comprising a platinum group metal, and, subsequently, contacting the exhaust gas with at least one entity chosen from a platinum group metal capture material as disclosed herein, a catalytic article as disclosed herein, and an exhaust gas treatment system as disclosed herein.

Some embodiments of the present disclosure relate to gas treatment systems comprising a means for oxidizing carbon monoxide and oxidizing hydrocarbons, a means for capturing a volatilized platinum group metal, and a means for selectively reducing nitrogen oxides: wherein the means for oxidizing carbon monoxide and oxidizing hydrocarbons comprises a platinum group metal, the means for capturing a volatilized platinum group metal comprises magnesium oxide, the means for capturing a volatilized platinum group metal does not comprise a transition metal except, optionally, zirconium, the means for capturing a volatilized platinum group metal does not comprise a rare earth metal, the means for capturing a volatilized platinum group metal is located downstream of the means for oxidizing carbon monoxide and oxidizing hydrocarbons, and the means for capturing a volatilized platinum group metal is located upstream of the means for selectively reducing nitrogen oxides.

In some embodiments, the means for capturing a volatilized platinum group metal comprises a platinum group metal capture material as disclosed herein.

### BRIEF DESCRIPTION OF THE DRAWINGS

To provide an understanding of the embodiments of the present disclosure, reference is made to the appended figures. The figures are exemplary and should not be construed as limiting the disclosure.

FIG. 1 depicts an experimental setup for studying platinum group metal migration.

FIG. 2 depicts SCR-out NOₓ conversion of some exemplary embodiments after platinum migration.

FIG. 3 depicts SCR-out N₂O generation of some exemplary embodiments after platinum migration.

FIG. 4 depicts Pt concentration (ppm) of some exemplary embodiments via fire assay after platinum migration.

FIG. 5 depicts SCR-out NOₓ conversion of some exemplary embodiments after 50 hours platinum migration aging.

FIG. 6 depicts the distribution of platinum species on some exemplary embodiments by X-ray photoelectron spectroscopy (XPS).

### Definitions

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, the term “about” refers to a range of ±5% of the stated number. For example, “about 100” means a number ranging from 95 to 105 including, e.g., 95, 100, and 105. Unless otherwise stated, all numbers are assumed to be modified by “about”.

As used herein, the term “platinum group metal,” abbreviated “PGM,” refers to ruthenium, (Ru) rhodium (Rh), palladium (Pd), osmium (Os), iridium (Ir), platinum (Pt), and combinations thereof.

As used herein, the term “noble metal” refers to ruthenium (Ru), rhodium (Rh), palladium (Pd), osmium (Os), iridium (Ir), platinum (Pt), gold (Au), silver (Ag), copper (Cu), rhenium (Re), mercury (Hg), and combinations thereof.

As used herein, the term “rare earth metal” refers to scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and combinations thereof.

As used herein, the term “diesel oxidation catalyst,” abbreviated “DOC,” refers to a catalyst, comprising a platinum group metal, capable of oxidizing carbon monoxide and hydrocarbons.

As used herein, the term “NOₓ” refers to nitrogen oxides and mixtures thereof. Exemplary nitrogen oxides include, but are not limited to, NO, N₂O, NO₂, and N₂O₂.

As used herein, the term “NOₓ reduction component” refers to a component such as a composition and/or article that is capable of reducing NOₓ. Exemplary NOₓ reduction components include, but are not limited to, selective catalytic reduction (SCR) catalysts and lean NOₓ traps (LNT) including, but not limited to, LNTs employing Pt, Pd, Rh, operating in alternating lean and rich pulses.

As used herein, the term “selective catalytic reduction catalyst,” abbreviated SCR catalyst” refers to a catalyst capable of selectively reducing NOₓ to N₂ and water, optionally in the presence of a reductant such as NH₃.

As used herein, “particle size D₉₀” refers to the particle size at which about 90% of the particles have a smaller particle size.

As used herein, the term “washcoat” refers to a coating applied to a substrate.

As used herein, a second entity is “downstream” of a first entity if the two entities are in fluid communication and fluid, such as an exhaust gas, flows from the first entity to the second entity, and there may or may not be one or more additional entities in fluid communication between the first and second entity.

As used herein, a first entity is “upstream” of a second entity if the second entity is downstream of the first entity.

### Platinum Group Metal Capture Materials:

In some embodiments, a platinum group metal capture material comprises an alkaline earth metal oxide.

In some embodiments, the platinum group metal capture material comprises less than about 0.01 weight % of platinum group metals by total weight of the platinum group metal capture material. In some embodiments, the platinum group metal capture material comprises less than about 0.01 weight % of noble metals by total weight of the platinum group metal capture material. In some embodiments, the platinum group metal capture material comprises less than about 0.01 weight % of rare earth metals by total weight of the platinum group metal capture material. In some embodiments, the platinum group metal capture material comprises less than about 0.01 weight % of transition metals except, optionally, zirconium, by total weight of the platinum group metal capture material. In some embodiments, the platinum group metal capture material comprises less than about 0.01 weight % of ceria, gold, palladium, silver, platinum, and copper by total weight of the platinum group metal capture material.

In some embodiments, the platinum group metal capture material does not comprise a platinum group metal. In some embodiments, the platinum group metal capture material does not comprise a noble metal. In some embodiments, the platinum group metal capture material does not comprise a rare earth metal. In some embodiments, the platinum group metal capture material does not comprise a transition metal except, optionally, zirconium. In some embodiments, the platinum group metal capture material does not comprise a transition metal. In some embodiments, the platinum group metal capture material does not comprise ceria, gold, palladium, silver, platinum, and copper.

In some embodiments, the platinum group metal capture material does not comprise any platinum group metal. In some embodiments, the platinum group metal capture material does not comprise any noble metal. In some embodiments, the platinum group metal capture material does not comprise any rare earth metal.

In some embodiments, the alkaline earth metal oxide is chosen from magnesium oxide, barium oxide, calcium oxide, strontium oxide, and combinations thereof. In some embodiments, the alkaline earth metal oxide comprises magnesium oxide. In some embodiments, the alkaline earth metal oxide comprises barium oxide. In some embodiments, the alkaline earth metal oxide comprises calcium oxide. In some embodiments, the alkaline earth metal oxide comprises strontium oxide.

In some embodiments, the platinum group metal capture material further comprises at least one metal oxide chosen from alumina, zirconia, and combinations thereof. In some embodiments, the platinum group metal capture material further comprises alumina. In some embodiments, the platinum group metal capture material further comprises zirconia.

In some embodiments, the platinum group metal capture material has from about 30 weight % to about 100 weight % of magnesium oxide by total weight of the platinum group metal capture material. In some embodiments, the platinum group metal capture material has from about 40 weight % to about 100 weight % of magnesium oxide by total weight of the platinum group metal capture material. In some embodiments, the platinum group metal capture material has from about 50 weight % to about 100 weight % of magnesium oxide by total weight of the platinum group metal capture material. In some embodiments, the platinum group metal capture material has from about 60 weight % to about 100 weight % of magnesium oxide by total weight of the platinum group metal capture material. In some embodiments, the platinum group metal capture material has from about 70 weight % to about 100 weight % of magnesium oxide by total weight of the platinum group metal capture material. In some embodiments, the platinum group metal capture material has from about 80 weight % to about 100 weight % of magnesium oxide by total weight of the platinum group metal capture material. In some embodiments, the platinum group metal capture material has from about 90) weight % to about 100 weight % of magnesium oxide by total weight of the platinum group metal capture material. In some embodiments, the platinum group metal capture material has from about 60 weight % to about 95 weight % of magnesium oxide by total weight of the platinum group metal capture material. In some embodiments, the platinum group metal capture material has from about 70 weight % to about 95 weight % of magnesium oxide by total weight of the platinum group metal capture material. In some embodiments, the platinum group metal capture material has from about 80 weight % to about 95 weight % of magnesium oxide by total weight of the platinum group metal capture material. In some embodiments, the platinum group metal capture material has from about 70 weight % to about 90 weight % of magnesium oxide by total weight of the platinum group metal capture material. In some embodiments, the platinum group metal capture material has about 30 weight % of magnesium oxide by total weight of the platinum group metal capture material. In some embodiments, the platinum group metal capture material has about 40 weight % of magnesium oxide by total weight of the platinum group metal capture material. In some embodiments, the platinum group metal capture material has about 50 weight % of magnesium oxide by total weight of the platinum group metal capture material. In some embodiments, the platinum group metal capture material has about 60 weight % of magnesium oxide by total weight of the platinum group metal capture material. In some embodiments, the platinum group metal capture material has about 70 weight % of magnesium oxide by total weight of the platinum group metal capture material. In some embodiments, the platinum group metal capture material has about 80 weight % of magnesium oxide by total weight of the platinum group metal capture material. In some embodiments, the platinum group metal capture material has about 90 weight % of magnesium oxide by total weight of the platinum group metal capture material. In some embodiments, the platinum group metal capture material has about 95 weight % of magnesium oxide by total weight of the platinum group metal capture material. In some embodiments, the platinum group metal capture material has about 100 weight % of magnesium oxide by total weight of the platinum group metal capture material.

In some embodiments, the platinum group metal capture material consists essentially of aluminum magnesium oxide, zirconia magnesium oxide, aluminum calcium oxide, zirconia calcium oxide, or combinations thereof. In some embodiments, the platinum group metal capture material consists essentially of aluminum magnesium oxide, zirconia magnesium oxide, aluminum calcium oxide, or zirconia calcium oxide. In some embodiments, the platinum group metal capture material consists essentially of aluminum magnesium oxide. In some embodiments, the platinum group metal capture material consists essentially of zirconia magnesium oxide. In some embodiments, the platinum group metal capture material consists essentially of aluminum calcium oxide. In some embodiments, the platinum group metal capture material consists essentially of zirconia calcium oxide. In some embodiments, the platinum group metal capture material consists essentially of aluminum magnesium oxide and zirconia magnesium oxide. In some embodiments, the platinum group metal capture material consists essentially of aluminum magnesium oxide and aluminum calcium oxide. In some embodiments, the platinum group metal capture material consists essentially of aluminum magnesium oxide and zirconia calcium oxide. In some embodiments, the platinum group metal capture material consists essentially of zirconia magnesium oxide and aluminum calcium oxide. In some embodiments, the platinum group metal capture material consists essentially of zirconia magnesium oxide and zirconia calcium oxide. In some embodiments, the platinum group metal capture material consists essentially of aluminum calcium oxide and zirconia calcium oxide.

In some embodiments, the platinum group metal capture material consists essentially of magnesium oxide.

In some embodiments, the following are non-limiting exemplary components that do not materially affect the basic and novel properties of the platinum group metal capture material: binders (e.g., about 0.1 weight % to about 10 weight % basic alumina binder, about 0.1 weight % to about 10 weight % silica binder, about 0.1 weight % to about 10 weight % zirconia, and combinations thereof) and combinations thereof. In some embodiments, binders include about 0.1 weight % to about 10 weight % colloidal ceria binder. In some embodiments, binders do not include about 0.1 weight % to about 10 weight % colloidal ceria binder. In some embodiments, colloidal ceria binder is different and distinct from an active ceria capture material in a mixed oxide form. In some embodiments, colloidal ceria binder is different and distinct from an active ceria capture material in a bulk high surface area form. In some embodiments, the platinum group metal capture material consists of magnesium oxide.

### Catalytic Articles:

In some embodiments, a catalytic article comprises a platinum group metal capture material as disclosed herein downstream of a catalytic composition comprising a platinum group metal. In some embodiments, a catalytic article comprises a platinum group metal capture material disclosed herein upstream of a NOₓ reduction component.

In some embodiments, the platinum group metal capture material has a washcoat loading of at least about 0.1 g/in³. In some embodiments, the platinum group metal capture material has a washcoat loading ranging from about 0.1 g/in³ to about 2 g/in³. In some embodiments, the platinum group metal capture material has a washcoat loading ranging from about 0.1 g/in³ to about 1 g/in³. In some embodiments, the platinum group metal capture material has a washcoat loading ranging from about 1 g/in³ to about 2 g/in³.

In some embodiments, platinum group metal capture material and the catalytic composition are in a layered arrangement. In some embodiments, the platinum group metal capture material and the catalytic composition are in a zoned arrangement.

In some embodiments, the platinum group metal capture material and the NOₓ reduction component are in a layered arrangement. In some embodiments, the platinum group metal capture material and the NOₓ reduction component are in a zoned arrangement. In some embodiments, the NOₓ reduction component comprises a zeolite ion-exchanged with copper and/or iron. In some embodiments, the NOₓ reduction component comprises a zeolite ion-exchanged with copper and iron. In some embodiments, the NOₓ reduction component comprises a zeolite ion-exchanged with copper or iron. In some embodiments, the NOₓ reduction component comprises a zeolite ion-exchanged with copper. In some embodiments, the NOₓ reduction component comprises a zeolite ion-exchanged with iron.

### Substrates:

In some embodiments, one or more catalytic compositions and/or platinum group metal capture materials are disposed on one or more substrates to form, e.g., a catalytic article. In some embodiments, the one or more substrates are 3-dimensional and have a length, a diameter, and a volume. In some embodiments, the one or more substrates are cylindrical. In some embodiments, the one or more substrates are not cylindrical. In some embodiments, the one or more substrates have an axial length from an inlet end to an outlet end.

In some embodiments, the one or more substrates are ceramic substrates. In some embodiments, the ceramic substrates are made of any suitable refractory material, e.g., cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

In some embodiments, substrates comprise one or more metals or metal alloys. In some embodiments, a metallic substrate may include any metallic substrate, such as those with openings or “punch-outs” in the channel walls. In some embodiments, the metallic substrates may be employed in various shapes, such as pellets, compressed metallic fibers, corrugated sheets, or monolithic foams. In some embodiments, metallic substrates include heat-resistant, base-metal alloys, especially those in which iron is a substantial or major component. Such alloys may contain one or more of nickel, chromium, and aluminum, and the total of these metals may comprise at least about 15 wt % (weight percent) of the alloy, for instance, about 10 wt % to about 25 wt % chromium, about 1 wt % to about 8 wt % of aluminum, and about 0) wt % to about 20 wt % of nickel, in each case based on the weight of the substrate. In some embodiments, metallic substrates include those having straight channels; those having protruding blades along the axial channels to disrupt gas flow and to open communication of gas flow between channels; and those having blades and also holes to enhance gas transport between channels allowing for radial gas transport throughout the monolith.

In some embodiments, any suitable substrate may be employed, such as a monolithic substrate of the type having fine, parallel gas flow passages extending therethrough from an inlet or an outlet face of the substrate such that passages are open to fluid flow therethrough (“flow-through substrate”). In some embodiments, a substrate has a plurality of fine, substantially parallel gas flow passages extending along the longitudinal axis of the substrate where, e.g., each passage is blocked at one end of the substrate body, with alternate passages blocked at opposite end-faces (“wall-flow filter”).

In some embodiments, the substrate comprises a honeycomb substrate in the form of a wall-flow filter or a flow-through substrate. In some embodiments, the substrate is a wall-flow filter. In some embodiments, the substrate is a flow-through substrate.

In some embodiments, the substrate is a flow-through substrate (e.g., a monolithic substrate, including a flow-through honeycomb monolithic substrate). In some embodiments, flow-through substrates have fine, parallel gas flow passages extending from an inlet end to an outlet end of the substrate such that passages are open to fluid flow. In some embodiments, passages, which are paths from the inlet to the outlet, have walls on or in which a coating is disposed so that gases flowing through the passages contact the coated material. In some embodiments, the flow passages of the flow-through substrate are thin-walled channels, which can be of any suitable cross-sectional shape and size such as trapezoidal, rectangular, square, sinusoidal, hexagonal, oval, circular, etc. The flow-through substrate can be ceramic or metallic as described above.

In some embodiments, flow-through substrates have a volume of from about 50 in³ to about 1200 in³, a cell density (inlet openings) of from about 60 cells per square inch (cpsi) to about 500 cpsi or up to about 900 cpsi, for example, from about 200 to about 400 cpsi, and a wall thickness of from about 50 microns to about 200 microns or about 400 microns.

In some embodiments, the substrate is a wall-flow filter having a plurality of fine passages extending along the longitudinal axis of the substrate. In some embodiments, each passage is blocked at one end of the substrate body, with alternate passages blocked at opposite end-faces. In some embodiments, monolithic wall-flow filter substrates may contain up to about 900 or more flow passages (or “cells”) per square inch of cross-section, although fewer may be used. For example, the substrate may have from about 7 to about 600, e.g., from about 100 to about 400, cells per square inch (“cpsi”). In some embodiments, the cells have cross-sections that are rectangular, square, circular, oval, triangular, hexagonal, or are of other polygonal shapes. In some embodiments, the wall-flow filter substrate is ceramic or metallic as described above.

In some embodiments, the wall-flow filter article substrate has a volume of, for example, from about 50 cm³, about 100 in³, about 200 in³, about 300 in³, about 400 in³, about 500 in³, about 600 in³, about 700 in³, about 800 in³, about 900 in³ or about 1000 in³ to about 1500 in³, about 2000 in³, about 2500 in³, about 3000 in³, about 3500 in³, about 4000 in³, about 4500 in³ or about 5000 in³. In some embodiments, wall-flow filter substrates have a wall thickness from about 50 microns to about 2000 microns, for example from about 50 microns to about 450 microns or from about 150 microns to about 400 microns.

In some embodiments, the walls of the wall-flow filter are porous and have a wall porosity of at least about 40% or at least about 50% with an average pore diameter of at least about 10 microns prior to disposition of the functional coating. For example, in some embodiments, the wall-flow filter article substrate has a porosity of ≥40%, ≥50%, ≥60%, ≥ 65%, or ≥70%. In some embodiments, the wall-flow filter article substrate has a wall porosity of from about 50%, about 60%, about 65% or about 70% to about 75% and an average pore diameter of from about 10 microns, or about 20 microns, to about 30 microns, or about 40 microns prior to disposition of a catalytic coating. The terms “wall porosity” and “substrate porosity” mean the same thing and are used interchangeably herein. Porosity is the ratio of void volume (or pore volume) divided by the total volume of a substrate material. Pore size and pore size distribution may be determined by, e.g., Hg porosimetry measurement.

In some embodiments, a composition is mixed with water to form a slurry for the purposes of coating a substrate. In some embodiments, the slurry further comprises an inorganic binder, an associative thickener, or a surfactant (e.g., one or more anionic, cationic, non-ionic or amphoteric surfactants). The order of addition can vary: in some embodiments, all components are simply combined together to form the slurry and, in some embodiments, certain components are combined and remaining components are then combined therewith. In some embodiments, the pH of the slurry can be adjusted, e.g., to an acidic pH of about 3 to about 5.

In some embodiments, the slurry is milled. In some embodiments, the milling is accomplished in a ball mill, continuous mill, or other similar equipment, and the solids content of the slurry may be, e.g., about 20 wt. %, to about 60 wt. %, about 30 wt. %, to about 40 wt. %. In some embodiments, the post-milling slurry is characterized by a D₉₀ particle size of about 10 microns to about 50 microns (e.g., about 10 microns to about 20 microns).

### Washcoats:

In some embodiments, a slurry is coated on a substrate using a washcoat technique known in the art. Washcoats are, for example, as described in Heck, Ronald and Robert Farrauto, Catalytic Air Pollution Control, New York: Wiley-Interscience, 2002, pp. 18-19, a compositionally distinct layer of material disposed on the surface of a monolithic substrate or an underlying washcoat layer. In some embodiments, a substrate contains one or more washcoat layers, and each washcoat layer can have different composition.

In some embodiments, the substrate is dipped one or more times in the slurry or otherwise coated with the slurry. In some embodiments, the coated substrate is dried at an elevated temperature (e.g., about 100° C. to about 150° C.) in static air or under a flow or jet of air for about 2 minutes to about 3 hours, and then calcined by heating, e.g., at about 400° C. to about 600° C., for about 10 minutes to about 3 hours. In some embodiments, following drying and calcining, the final washcoat coating layer is essentially solvent-free.

In some embodiments, after calcining, the washcoat loading can be determined through calculation of the difference in coated and uncoated weights of the substrate. As will be apparent to those of skill in the art, the washcoat loading can be modified by altering the slurry rheology or solids content. In some embodiments, the coating/drying/calcining process is repeated as needed to build the coating to the desired loading level or thickness.

In some embodiments, a composition is applied as a single layer or in multiple layers. In some embodiments, a layer resulting from repeated wash-coating of the same material to build up the loading level is a single layer. In some embodiments, a composition can be zone-coated, meaning a single substrate can be coated with different catalyst compositions in different areas along the gas effluent flow path.

### Exhaust Gas Treatment Systems:

In some embodiments, an exhaust gas treatment system comprises an engine and a platinum group metal capture material disclosed herein. In some embodiments, an exhaust gas treatment system comprises an engine and a catalytic article disclosed herein.

In some embodiments, an exhaust gas treatment system comprises the platinum group metal capture material disclosed herein downstream of a catalytic composition comprising a platinum group metal, and the platinum group metal capture material and the catalytic composition are on different substrates. In some embodiments, an exhaust gas treatment system comprises the platinum group metal capture material disclosed herein downstream of a catalytic composition comprising a platinum group metal, and the platinum group metal capture material and the catalytic composition are on the same substrates.

In some embodiments, an exhaust gas treatment system comprises the platinum group metal capture material disclosed herein upstream of a catalytic composition comprising a zeolite ion-exchanged with copper and/or iron, and the platinum group metal capture material and the catalytic composition are on different substrates. In some embodiments, an exhaust gas treatment system comprises the platinum group metal capture material disclosed herein upstream of a catalytic composition comprising a zeolite ion-exchanged with copper and/or iron, and the platinum group metal capture material and the catalytic composition are on the same substrate.

In some embodiments, an exhaust gas treatment system comprises: a means for oxidizing carbon monoxide and oxidizing hydrocarbons, a means for capturing a volatilized platinum group metal, and a means for selectively reducing nitrogen oxides: wherein the means for oxidizing carbon monoxide and oxidizing hydrocarbons comprises a platinum group metal, the means for capturing a volatilized platinum group metal comprises magnesium oxide, the means for capturing a volatilized platinum group metal does not comprise a transition metal except, optionally, zirconium, the means for capturing a volatilized platinum group metal does not comprise a rare earth metal, the means for capturing a volatilized platinum group metal is located downstream of the means for oxidizing carbon monoxide and oxidizing hydrocarbons, and the means for capturing a volatilized platinum group metal is located upstream of the means for selectively reducing nitrogen oxides.

In some embodiments, the means for capturing a volatilized platinum group metal comprises a platinum group metal capture material disclosed herein.

In some embodiments, the means for oxidizing carbon monoxide and oxidizing hydrocarbons is a diesel oxidation catalyst. In some embodiments, the means for selectively reducing nitrogen oxides comprises a zeolite ion-exchanged with copper and/or iron. In some embodiments, the means for selectively reducing nitrogen oxides is a selective catalytic reduction catalyst.

### Methods of Treating an Exhaust Gas:

In some embodiments, a method of treating an exhaust gas comprises: contacting the exhaust gas with a catalytic composition comprising a platinum group metal, and, subsequently, contacting the exhaust gas with at least one entity chosen from a platinum group metal capture material disclosed herein, a catalytic article disclosed herein, and an exhaust gas treatment system disclosed herein.

### Diesel Oxidation Catalysts:

Diesel oxidation catalysts provide an exemplary means for oxidizing carbon monoxide and oxidizing hydrocarbons. Non-limiting exemplary diesel oxidation catalysts comprise one or more platinum group metals. Non-limiting exemplary diesel oxidation catalysts are disclosed in International Application No. PCT/US2010/021048, filed Jan. 14, 2010; International Application No. PCT/US2010/030226, filed Apr. 7, 2010; International Application No. PCT/US2013/057011, filed Aug. 28, 2013; International Application No. PCT/US2014/070356, filed Dec. 15, 2014; and International Application No. PCT/EP2018/053568, filed Feb. 13, 2018; the disclosure of each of which is incorporated herein by reference herein in its entirety.

### NO, Reduction Components:

NOₓ reduction components, such as selective catalytic reduction catalysts, provide an exemplary means for selectively reducing nitrogen oxides. Non-limiting exemplary selective catalytic reduction catalysts comprise a zeolite ion-exchanged with copper and/or iron. Non-limiting exemplary NOₓ reduction components are disclosed in International Application No. PCT/IB2011/051526, filed Apr. 8, 2011; International Application No. PCT/US2013/065498, filed Oct. 17, 2013; International Application No. PCT/EP2019/069878, filed Jul. 24, 2019; International Application No. PCT/EP2019/079081, filed Oct. 24, 2019; and International Application No. PCT/US2016/019842, filed Feb. 26, 2016; the disclosure of each of which is incorporated herein by reference in its entirety.

### NON-LIMITING EXEMPLARY EMBODIMENTS

Without limitation, some embodiments of this disclosure include:
1. A platinum group metal capture material comprising an alkaline earth metal oxide.
2. The platinum group metal capture material according to embodiment 1, wherein the platinum group metal capture material comprises less than about 0.01 weight % of platinum group metal(s) by total weight of the platinum group metal capture material.
3. The platinum group metal capture material according to embodiment 1 or 2, wherein the platinum group metal capture material comprises less than about 0.01 weight % of noble metal(s) by total weight of the platinum group metal capture material.
4. The platinum group metal capture material according to any one of embodiments 1 to 3, wherein the platinum group metal capture material comprises less than about 0.01 weight % of rare earth metal(s) by total weight of the platinum group metal capture material.
5. The platinum group metal capture material according to any one of embodiments 1 to 4, wherein the platinum group metal capture material comprises less than about 0.01 weight % of transition metals except, optionally, zirconium, by total weight of the platinum group metal capture material.
6. The platinum group metal capture material according to any one of embodiments 1 to 5, wherein the platinum group metal capture material comprises less than about 0.01 weight % of ceria, gold, palladium, silver, platinum, and copper by total weight of the platinum group metal capture material.
7. The platinum group metal capture material according to any one of embodiments 1 to 6, wherein the platinum group metal capture material does not comprise a platinum group metal.
8. The platinum group metal capture material according to any one of embodiments 1 to 7 wherein the platinum group metal capture material does not comprise any platinum group metals.
9. The platinum group metal capture material according to any one of embodiments 1 to 8, wherein the platinum group metal capture material does not comprise a noble metal.
10. The platinum group capture material according to any one of claims 1 to 9, wherein the platinum group metal capture material does not comprise any noble metals.
11. The platinum group metal capture material according to any one of embodiments 1 to 10, wherein the platinum group metal capture material does not comprise a rare earth metal
12. The platinum group metal capture material according to any one of embodiments 1 to 11, wherein the platinum group metal capture material does not comprise any rare earth metals.
13. The platinum group metal capture material according to any one of embodiments 1 to 12, wherein the platinum group metal capture material does not comprise a transition metal except, optionally, zirconium.
14. The platinum group metal capture material according to any one of embodiments 1 to 13, wherein the platinum group capture material does not comprise any transition metals except, optionally, zirconium.
15. The platinum group metal capture material according to any one of embodiments 1 to 14, wherein the platinum group metal capture material does not comprise a transition metal.
16. The platinum group capture material according to any one of embodiments 1 to 15, wherein the platinum group capture material does not comprise any transition metals.
17. The platinum group metal capture material according to any one of embodiments 1 to 16, wherein the platinum group metal capture material does not comprise ceria, gold, palladium, silver, platinum, and copper.
18. The platinum group metal capture material according to any one of embodiments 1 to 17, wherein the platinum group metal capture material does not comprise ceria.
19. The platinum group metal capture material according to any one of embodiments 1 to 17, wherein the platinum group metal capture material does not comprise gold.
20. The platinum group metal capture material according to any one of embodiments 1 to 17, wherein the platinum group metal capture material does not comprise palladium.
21. The platinum group metal capture material according to any one of embodiments 1 to 17, wherein the platinum group metal capture material does not comprise silver.
22. The platinum group metal capture material according to any one of embodiments 1 to 17, wherein the platinum group metal capture material does not comprise platinum.
23. The platinum group metal capture material according to any one of embodiments 1 to 17, wherein the platinum group metal capture material does not comprise copper.
24. The platinum group metal capture material according to any one of embodiments 1 to 23, wherein the alkaline earth metal oxide is chosen from magnesium oxide, barium oxide, calcium oxide, strontium oxide, and combinations thereof.
25. The platinum group metal capture material according to any one of embodiments 1 to 24, wherein the alkaline earth metal oxide comprises magnesium oxide.
26. The platinum group metal capture material according to any one of embodiments 1 to 24, wherein the alkaline earth metal oxide comprises barium oxide.
27. The platinum group metal capture material according to any one of embodiments 1 to 24, wherein the alkaline earth metal oxide comprises calcium oxide.
28. The platinum group metal capture material according to any one of embodiments 1 to 24, wherein the alkaline earth metal oxide comprises strontium oxide.
29. The platinum group metal capture material according to any one of embodiments 1 to 28, further comprising at least one metal oxide chosen from alumina, zirconia, and combinations thereof.
30. The platinum group metal capture material according to any one of embodiments 1 to 29, further comprising alumina.
31. The platinum group metal capture material according to any one of embodiments 1 to 29, further comprising zirconia.
32. The platinum group metal capture material according to any one of embodiments 1 to 31, wherein the platinum group metal capture material has from about 30 weight % to about 100 weight % of magnesium oxide by total weight of the platinum group metal capture material.
33. The platinum group metal capture material according to any one of embodiments 1 to 31, wherein the platinum group metal capture material has from about 50 weight % to about 100 weight % of magnesium oxide by total weight of the platinum group metal capture material.
34. The platinum group metal capture material according to any one of embodiments 1 to 31, wherein the platinum group metal capture material has from about 60 weight % to about 100 weight % of magnesium oxide by total weight of the platinum group metal capture material.
35. The platinum group metal capture material according to any one of embodiments 1 to 31, wherein the platinum group metal capture material has from about 70 weight % to about 100 weight % of magnesium oxide by total weight of the platinum group metal capture material.
36. The platinum group metal capture material according to any one of embodiments 1 to 31, wherein the platinum group metal capture material has from about 80 weight % to about 100 weight % of magnesium oxide by total weight of the platinum group metal capture material.
37. The platinum group metal capture material according to any one of embodiments 1 to 31, wherein the platinum group metal capture material has from about 90 weight % to about 100 weight % of magnesium oxide by total weight of the platinum group metal capture material.
38. The platinum group metal capture material according to any one of embodiments 1 to 31, wherein the platinum group metal capture material has from about 60 weight % to about 95 weight % of magnesium oxide by total weight of the platinum group metal capture material.
39. The platinum group metal capture material according to any one of embodiments 1 to 31, wherein the platinum group metal capture material has from about 70 weight % to about 95 weight % of magnesium oxide by total weight of the platinum group metal capture material.
40. The platinum group metal capture material according to any one of embodiments 1 to 1315, wherein the platinum group metal capture material has from about 80 weight % to about 95 weight % of magnesium oxide by total weight of the platinum group metal capture material.
41. The platinum group metal capture material according to any one of embodiments 1 to 31, wherein the platinum group metal capture material has from about 70 weight % to about 90 weight % of magnesium oxide by total weight of the platinum group metal capture material.
42. The platinum group metal capture material according to any one of embodiments 1 to 31, wherein the platinum group metal capture material consists essentially of magnesium oxide.
43. The platinum group metal capture material according to any one of embodiments 1 to 31, wherein the platinum group metal capture material consists of magnesium oxide.
44. The platinum group metal capture material according to any one of embodiments 1 to 31, wherein the platinum group metal capture material consists essentially of aluminum magnesium oxide, zirconia magnesium oxide, aluminum calcium oxide, or zirconia calcium oxide.
45. The platinum group metal capture material according to any one of embodiments 1 to 31, wherein the platinum group metal capture material consists essentially of aluminum magnesium oxide.
46. The platinum group metal capture material according to any one of embodiments 1 to 31, wherein the platinum group metal capture material consists essentially of zirconia magnesium oxide.
47. The platinum group metal capture material according to any one of embodiments 1 to 31, wherein the platinum group metal capture material consists essentially of aluminum calcium oxide.
48. The platinum group metal capture material according to any one of embodiments 1 to 31, wherein the platinum group metal capture material consists essentially of zirconia calcium oxide.
49. A catalytic article comprising the platinum group metal capture material according to any one of embodiments 1 to 48 downstream of a catalytic composition comprising a platinum group metal.
50. The catalytic article according to embodiment 49, wherein the platinum group metal capture material has a washcoat loading of at least about 0.1 g/in³.
51. The catalytic article according to embodiment 49, wherein the platinum group metal capture material has a washcoat loading ranging from about 0.1 g/in³ to about 2 g/in³.
52. The catalytic article according to embodiment 49, wherein the platinum group metal capture material has a washcoat loading ranging from about 0.1 g/in³ to about 1 g/in³.
53. The catalytic article according to embodiment 49, wherein the platinum group metal capture material has a washcoat loading ranging from about 1 g/in³ to about 2 g/in³.
54. The catalytic article according to any one of embodiments 43 to 53, wherein the platinum group metal capture material and the catalytic composition are in a layered arrangement.
55. The catalytic article according to any one of embodiments 43 to 53, wherein the platinum group metal capture material and the catalytic composition are in a zoned arrangement.
56. A catalytic article comprising the platinum group metal capture material according to any one of embodiments 1 to 48 upstream of a NOₓ reduction component.
57. The catalytic article according to embodiment 56, wherein the platinum group metal capture material has a washcoat loading of at least about 0.1 g/in³.
58. The catalytic article according to embodiment 56, wherein the platinum group metal capture material has a washcoat loading ranging from about 0.1 g/in³ to about 2 g/in³.
59. The catalytic article according to embodiment 56, wherein the platinum group metal capture material has a washcoat loading ranging from about 0.1 g/in³ to about 1 g/in³.
60. The catalytic article according to embodiment 56, wherein the platinum group metal capture material has a washcoat loading ranging from about 1 g/in³ to about 2 g/in³.
61. The catalytic article according to any one of embodiments 56 to 60, wherein the platinum group metal capture material and the NOₓ reduction component are in a layered arrangement.
62. The catalytic article according to any one of embodiments 56 to 60, wherein the platinum group metal capture material and the NOₓ reduction component are in a zoned arrangement.
63. The catalytic article according to any one of embodiments 56 to 62, wherein the NOₓ reduction component comprises a zeolite ion-exchanged with copper and/or iron.
64. The catalytic article according to any one of embodiments 56 to 62, wherein the NOₓ reduction component comprises a zeolite ion-exchanged with copper.
65. The catalytic article according to any one of embodiments 56 to 62, wherein the NOₓ reduction component comprises a zeolite ion-exchanged with iron.
66. An exhaust gas treatment system comprising an engine and the platinum group metal capture material according to any one of embodiments 1 to 48.
67. An exhaust gas treatment system comprising an engine and the catalytic article according to any one of embodiments 49 to 63.
68. An exhaust gas treatment system comprising the platinum group metal capture material according to any one of embodiments 1 to 48 downstream of a catalytic composition comprising a platinum group metal, wherein the platinum group metal capture material and the catalytic composition are on different substrates.
69. An exhaust gas treatment system comprising the platinum group metal capture material according to any one of embodiments 1 to 48 downstream of a catalytic composition comprising a platinum group metal, wherein the platinum group metal capture material and the catalytic composition are on the same substrate.
70. A method of treating an exhaust gas, wherein the method comprises: contacting the exhaust gas with a catalytic composition comprising a platinum group metal, and, subsequently, contacting the exhaust gas with at least one entity chosen from the platinum group metal capture material according to any one of embodiments 1 to 48, the catalytic article according to any of embodiments 49 to 66, and the exhaust gas treatment system according to any one of embodiments 67 to 69.
71. An exhaust gas treatment system comprising: a means for oxidizing carbon monoxide and oxidizing hydrocarbons, a means for capturing a volatilized platinum group metal, and a means for selectively reducing nitrogen oxides: wherein the means for oxidizing carbon monoxide and oxidizing hydrocarbons comprises a platinum group metal, the means for capturing a volatilized platinum group metal comprises magnesium oxide, the means for capturing a volatilized platinum group metal does not comprise a transition metal except, optionally, zirconium, the means for capturing a volatilized platinum group metal does not comprise a rare earth metal, the means for capturing a volatilized platinum group metal is located downstream of the means for oxidizing carbon monoxide and oxidizing hydrocarbons, and the means for capturing a volatilized platinum group metal is located upstream of the means for selectively reducing nitrogen oxides.
72. The exhaust gas treatment system according to embodiment 71, wherein the means for capturing a volatilized platinum group metal comprises the platinum group metal capture material according to any one of embodiments 1 to 48.
73. The exhaust gas treatment system according to embodiment 71 or 72, wherein the means for oxidizing carbon monoxide and oxidizing hydrocarbons is a diesel oxidation catalyst.
74. The exhaust gas treatment system according to any one of embodiments 71 to 73, wherein the means for selectively reducing nitrogen oxides comprises a zeolite ion-exchanged with copper and/or iron.
75. The exhaust gas treatment system according to any one of embodiments 71 to 74, wherein the means for selectively reducing nitrogen oxides is a selective catalytic reduction catalyst.

### EXAMPLES

The following examples are intended to be illustrative and are not meant in any way to limit the scope of the disclosure.

### Control Example (No Platinum Group Metal Capture Material)

### Example 1 (Al₂O₃ Capture Material)

A gamma-Al₂O₃ material and 4% HOAc were added to deionized (DI) water to form a slurry suspension at approximately 45% solid content. The slurry was milled until the final particle size D₉₀ reached 12-15 micrometers; additional HOAc was added to adjust the pH to 4-4.5. The slurry was then coated at 38% solid content onto a 400/4 honeycomb substrate. After drying, the catalyst was calcined at 500° C. for 1 hour in air. The Al₂O₃ washcoat loading was 1.2 g/in³.

### Example 2 (Pd/Al₂O₃ Capture Material)

Monolith samples from Example 1 were coated with an additional Pd/Al₂O₃ top-coat. The gamma-Al₂O₃ material from Example 1 was impregnated with diluted Pd(NO₃)₂ solution. The Pd frit was added to DI water to form a slurry suspension at approximately 40% solid content. The slurry was milled until the final particle size D₉₀ reached 12-15 micrometers, to which a dispersed alumina binder at 5 weight % was added. The slurry was then coated at 36% solid content onto Example 1. After drying, the catalyst was calcined at 500° C. for 1 hour in air. The Pd loading was 2 g/ft³, and the Al₂O₃ loading was 0.25 g/in³.

### Example 3 (MgO Capture Material)

Mg(OH)₂ powder was added to DI water to form a slurry, to which up to 10 weight % ammonium polyacrylate dispersant was added. The slurry was mixed under high shear until the D₉₀ was <10-12 micrometers. About 5 wt % basic alumina binder was added to the slurry with a resulting pH of about 9.5. The slurry was then coated at 30% solid content onto a 400/4 honeycomb substrate. After drying, the catalyst was calcined at 550° C. for 1 hour in air. The MgO loading was 1.8 g/in³.

### Example 4 (70% MgO—Al₂O₃ Capture Material)

A composite material consisting of 70% MgO-30% Al₂O₃ was added to DI water to form a slurry, to which up to 10 wt % ammonium polyacrylate dispersant was added. The slurry was milled until the D₉₀ was <10-12 micrometers. About 5 wt % basic alumina binder was added to the slurry with a resulting pH of about 9.2. The slurry was then coated at 23% solid content onto a 400/4 honeycomb substrate. After drying, the catalyst was calcined at 550° C. for 1 hour in air. The MgO—Al₂O₃ loading was 1.1 g/in³.

### Example 5: Pt Migration Study

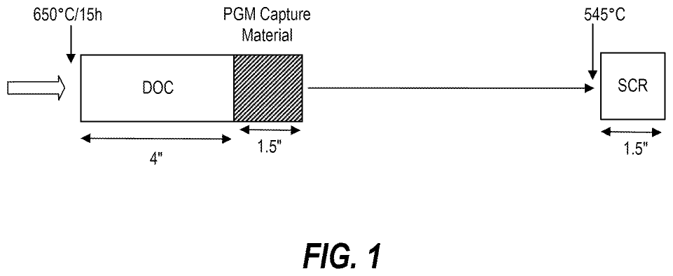

A Pt migration aging system was established to evaluate the efficiency of various Pt capture materials. As shown in FIG. 1, a 1×1×4″ DOC core sample, drilled from a commercial full-size DOC (10.5×10.5×4″) sample, was placed at the first position and served as the source of Pt migration. The DOC consists of a front zone (40% length) with 45 g/ft³ PGM loading at ½ Pt/Pd ratio, and a rear zone (60% length) with 15 g/ft³ PGM loading at 5/1 Pt/Pd ratio. The downstream SCR catalyst (1×1×1.5″) was also taken out of a commercial full-size Fe/CHA catalyst. A Pt trap core (1×1×1.5″) was placed at the DOC outlet without any gap in between. The Pt migration aging was conducted at DOC inlet T 650° C. for 15 hours in 10% steam air: the space velocity on the DOC was 35,000/h. The temperature at SCR-inlet was about 540-560° C. FIG. 1 depicts the experimental setup for the Pt migration study.

### Example 6: SCR Catalyst Testing Procedures

After each Pt migration aging test, the SCR core was evaluated with a steady state protocol at 350° C., 400° C., and 450° C. The feed composition consists of 500 ppm NH₃, 500 ppm NO, 7% H₂O, 10% O₂ in balanced N₂; the space velocity was 80,000/h.

### X-Ray Photoelectron Spectroscopy (XPS):

A monochromatized Al Ka source (1486 eV) is used to excite core level electrons. Samples are affixed to conductive carbon two-sided tape. Charging is compensated using an Ar flood gun. The binding energy is calibrated using adventitious carbon at 284.8 eV. Elemental quantification is obtained using a survey spectrum while the speciation is obtained from high resolution fine scan regions. The speciation is used to split the elemental quantification in order to give precise quantification of each species for a corresponding element. Peaks are fit using Gaussian-Lorentzian functions whose area is extracted and corrected by equipment specific relative sensitivity factors (RSFs) to calculate a semi-quantitative surface composition.

The distribution of detected Pt species by XPS was determined in a 1% Pt/Al₂O₃ sample, 1% Pt/ZrO₂ sample, and 1% Pt/MgO sample. These samples were prepared as follows.
XPS Sample 1 (1% Pt/Al₂O₃) was prepared by incipient wetness impregnation of an alumina carrier with a Pt ammine complex solution, followed with drying at 110° C. for 4 hours and calcination at 500° C. for 1 hour in air.
XPS Sample 2 (1% Pt/ZrO₂) was prepared by incipient wetness impregnation of a zirconia carrier with a Pt ammine complex solution, followed with drying at 110° C. for 4 hours and calcination at 500° C. for 1 hour in air.
XPS Sample 3 (1% Pt/MgO) was prepared by incipient wetness impregnation of a MgO carrier with a Pt ammine complex solution, followed with drying at 110° C. for 4 hours and calcination at 500° C. for 1 hour in air.

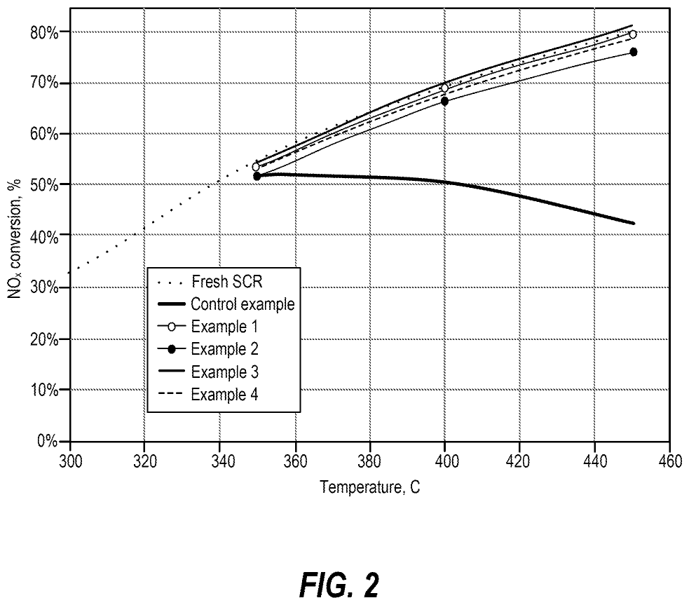

FIG. 2 compares the NOₓ conversion activity of SCR catalysts after Pt migration aging involving various platinum group metal capture materials. The control example is the SCR catalyst aged without the presence of any of Examples 1-4. Examples 1-4 all demonstrate excellent efficiency of protecting downstream SCR catalysts from Pt volatility from the front DOC, i.e., nearly no deactivation was observed at 350-450° C.

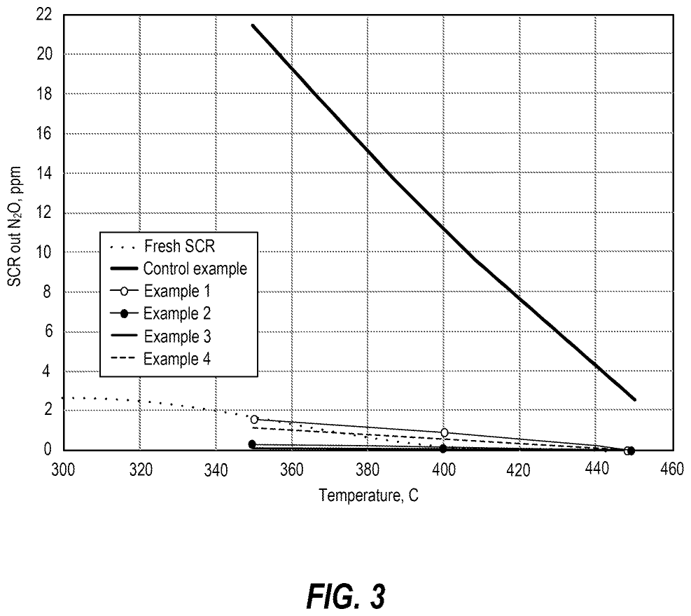

FIG. 3 compares N₂O generation by SCR catalysts after Pt migration aging involving various platinum group metal capture materials. The Control Example is the SCR catalyst aged without the presence of any of Examples 1-4, and shows a high level of N₂O production. Examples 1-4 show much lower N₂O level, either similar to that of fresh SCR catalyst or slightly lower.

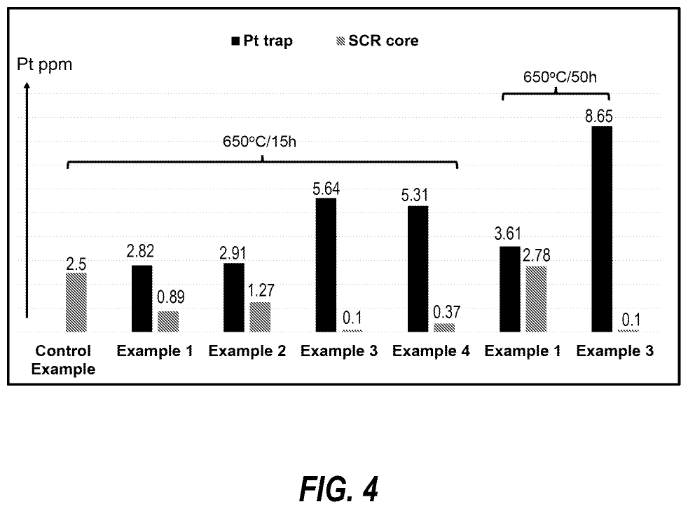

After completing SCR tests, both platinum group metal capture materials and downstream SCR cores were ground and measured for Pt concentration by fire assay. FIG. 4 compares the Pt concentration on aged cores. Examples 3 and 4 captured significantly higher amount of Pt than Example 1 and 2, and very little Pt was found on the SCR cores downstream of Example 3 and 4. As such, it is believed that Examples 3 and 4 are more efficient in retaining volatile Pt species than Example 1 and 2, which may be due to a strong affinity of Pt towards MgO surface. In fact, when Example 3 was subject to 50 hours of extended aging, the amount of Pt found on the downstream SCR catalyst remained at the fire assay detection limit (0.1 ppm), whereas 8.65 ppm Pt was found on Example 3. When Example 1 was subject to 50 hours of extended aging, only 3.61 Pt was found, whereas 2.78 ppm Pt was found on SCR, implying that Example 1, having a combination of Pd and Al₂O₃ as the PGM capture material, is not as effective in retaining volatized Pt as Example 3, that has only MgO as the PGM capture trap material.

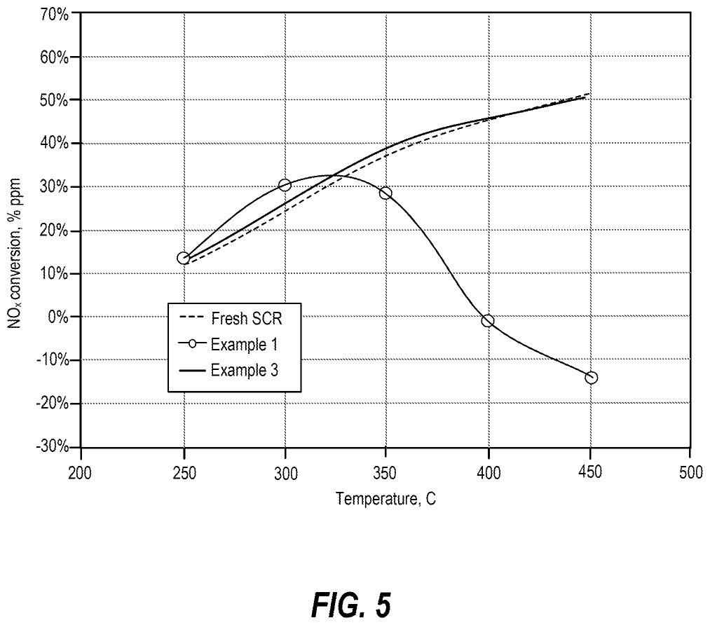

FIG. 5 compares the NOₓ conversion activity of SCR catalysts after 50 hours Pt migration aging. Severe SCR deactivation at ≥350° C. was observed when Example 1 was employed behind the DOC to capture volatized Pt, whereas SCR activity remained unchanged when Example 3 was used.

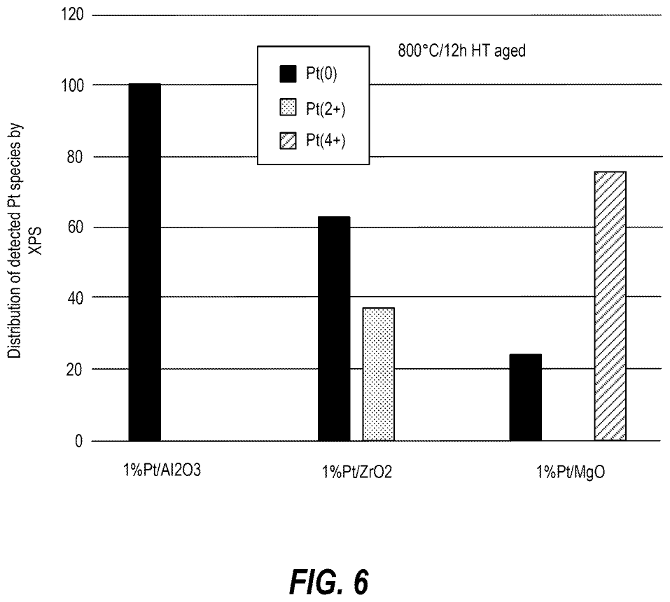

FIG. 6 depicts the distribution of detected Pt species by XPS on some exemplary platinum group metal capture materials after 800° C./12 hours hydrothermal (HT) aging. On a typical alumina or silica carrier, platinum oxides completely decompose to platinum metal at >600° C. and rampant particle sintering ensues at increasing temperature. As such, platinum was found present only in the Pt(0) oxidation state on Al₂O₃. By contrast, platinum was found in both the Pt(0) and Pt(2+) oxidation states on ZrO₂, and platinum was found in both the Pt(0) and Pt(4+) oxidation states on MgO. The presence of Pt(2+) and Pt(4+) is an indication of strong metal support interaction between platinum and the carrier, such interaction may stabilize platinum oxides from becoming volatile and decomposing to platinum metal.

Without wishing to be bound by theory, it is believed that the strength of the interaction between the Pt and the platinum group metal capture material increases with increasing oxidation state of the captured Pt species. For example, MgO is believed to have a stronger interaction strength than ZrO₂ which is believed to have a stronger interaction strength than Al₂O₃, so that platinum capture increases in the order of MgO>ZrO₂>Al₂O₃. Without wishing to be bound by theory, it is believed that the ability of some platinum group metal capture materials to bind platinum group metals in higher oxidation states is an exemplary reason for the surprisingly enhanced performance of the platinum group metal capture materials disclosed herein such as MgO.

Claims or descriptions that include “or” or “and/or” between at least one members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the following claims.

What is claimed is:

1. A platinum group metal capture material comprising an alkaline earth metal oxide, wherein the platinum group metal capture material comprises less than 0.01 weight % of ceria, gold, palladium, silver, platinum, and copper by total weight of the platinum group metal capture material.

2. The platinum group metal capture material according to claim 1, wherein the alkaline earth metal oxide is chosen from magnesium oxide, barium oxide, calcium oxide, strontium oxide, and combinations thereof.

3. The platinum group metal capture material according to claim 1, further comprising at least one metal oxide chosen from alumina, zirconia, and combinations thereof.

4. The platinum group metal capture material according to claim 2, wherein the platinum group metal capture material has from about 30 weight % to about 90 weight % of magnesium oxide by total weight of the platinum group metal capture material.

5. The platinum group metal capture material according to claim 1, wherein the platinum group metal capture material consists essentially of magnesium oxide.

6. The platinum group metal capture material according to claim 1, wherein the platinum group metal capture material consists essentially of aluminum magnesium oxide, zirconia magnesium oxide, aluminum calcium oxide, or zirconia calcium oxide.

7. A catalytic article comprising the platinum group metal capture material according to claim 1 downstream of a catalytic composition comprising a platinum group metal.

8. The catalytic article according to claim 7, wherein the platinum group metal capture material has a washcoat loading of at least 0.2 g/in³.

9. The catalytic article according to claim 7, wherein the platinum group metal capture material and the catalytic composition are in a layered arrangement and/or a zoned arrangement.

10. An exhaust gas treatment system comprising an engine and the catalytic article according to claim 7.

11. An exhaust gas treatment system comprising the platinum group metal capture material according to claim 1 downstream of a catalytic composition comprising a platinum group metal, wherein the platinum group metal capture material and the catalytic composition are on different substrates.

12. A method of treating an exhaust gas, wherein the method comprises: contacting the exhaust gas with a catalytic composition comprising a platinum group metal, and subsequently, contacting the exhaust gas with at least one entity chosen from the platinum group metal capture material according to claim 1.

13. An exhaust gas treatment system comprising:
a means for oxidizing carbon monoxide and oxidizing hydrocarbons,
a means for capturing a volatilized platinum group metal, and
a means for selectively reducing nitrogen oxides; wherein:
the means for oxidizing carbon monoxide and oxidizing hydrocarbons comprises a platinum group metal,
the means for capturing a volatilized platinum group metal comprises magnesium oxide,
the means for capturing a volatilized platinum group metal does not comprise a transition metal except, optionally, zirconium,
the means for capturing a volatilized platinum group metal does not comprise a rare earth metal,
the means for capturing a volatilized platinum group metal is located downstream of the means for oxidizing carbon monoxide and oxidizing hydrocarbons, and
the means for capturing a volatilized platinum group metal is located upstream of the means for selectively reducing nitrogen oxides.

14. The exhaust gas treatment system according to claim 13, wherein the means for capturing a volatilized platinum group metal comprises the platinum group metal capture material according to claim 1.
